(19) United States
(12) Patent Application Publication
(10) Pub. No.: US 2016/0017846 A1
(43) Pub. Date: Jan. 21, 2016

(54) FLUID SWITCHING DEVICE FOR A VALVE HAVING AT LEAST THREE PORTS

(71) Applicant: VALEO SYSTEMES DE CONTROLE MOTEUR, Cergy Saint Christophe (FR)

(72) Inventors: Grégory Hodebourg, Sartrouville (FR); Nicolas Martin, Maisonslafitte (FR)

(73) Assignee: Valeo Systemes de Controle Moteur, Cergy Saint Christophe (FR)

(21) Appl. No.: 14/773,517

(22) PCT Filed: Feb. 27, 2014
(86) PCT No.: PCT/FR2014/050429

§ 371 Date: Sep. 8, 2015

(30) Foreign Application Priority Data
Mar. 13, 2013 (FR) 1352230

(51) Int. Cl. F02M 25/07; F16K 11/052

(52) U.S. Cl. CPC F02M 25/0729; F16K 11/052; F02M 25/0793; F02M 25/0771

(57) ABSTRACT

A fluid switching device (1) for a valve having at least three ports, the device (1) comprising: a flap (10) capable of pivoting between a first position in which it blocks a first port (9) and a second position in which it blocks a second port (11), an actuating member (2) for actuating the flap (10), capable of moving the flap (10) from one blocking position to the other, the device (1) comprising an interface part (12) capable of interacting with the actuating member (2), the device (1) being configured in such a way that this interaction selectively allows the flap (10) to be moved by the actuating member (2) and selectively allows the flap (10) to be held in position, the actuating member (2) moving the flap (10) via a guide path (14) provided in the interface part (12).

The invention relates to a fluid switching device for a three-way valve, especially for an engine control valve.

The invention applies especially when the thermal engine is used to propel a vehicle, e.g. a motor vehicle. It may be an engine whose fuel is gasoline or diesel. The valve may be integrated in the air circuit of the thermal engine.

Within the meaning of the invention, the term “thermal engine air circuit” designates the circuit between the intake inlet and the exhaust outlet of the thermal engine. The valve can be placed in the intake circuit, the exhaust circuit, or a recirculating loop through which the exhaust gases re-injected pass at intake (EGR).

There is a need for a switching device which is relatively simple, robust and inexpensive.

The invention aims to meet this need.

It does so, according to one of its aspects, with a switching device of a fluid, especially for a valve having at least three ports, the device comprising:
a flap pivotable between a first blocking position of a first port and a second blocking position of a second port,
an actuating member of the flap capable of moving the flap from one to the other of the blocking positions,
   the device comprising an interface part capable of interacting with the actuating member, the device being configured in such a way that this interaction selectively allows the flap to be moved by the actuating member and selectively allows the flap to be held in position.

The actuator can move the flap through of a guide path provided in the interface part.

A movement of the actuating member can thus be transmitted to the flap through the interface part. This movement of the actuating member may be caused by an external actuator, for example a pneumatic, hydraulic or electric actuator. This external actuator may already be designed to move a flap of another valve. Alternatively, said external actuator is dedicated to driving the actuating member.

The flap, within the meaning of the present application, is a switching flap, which means that the flap will close off one port in favor of another port allowing the flow of the gases, and that it is not a priori intended to regulate a gas flow through a port.

The flap and the interface part may be separate parts rigidly coupled together. The flap and the interface part are, for example, separated by a seal preventing the fluid, such as gases, which is in contact with the flap, to reach the interface part and the actuating member. For the purposes of this application, the two parts are rigidly coupled to each other when there is no degree of freedom between them.

The actuating member and the interface part may have complementary surfaces so that the contact between these complementary surfaces holds in position the interface part when the actuating member is moving. The actuating member can then form an abutment at the surface cooperating with the interface part in order to hold the latter in position.

Thus, the actuating member above can alone play two actuating functions for fully controlling the movement of the flap. As already mentioned, the actuating member can allow the movement of the flap. In addition, the actuating member may, by cooperating with the interface part, hold the flap in position when the latter has reached a desired position, in particular a blocking position.

Thus, a movement of the actuating member may be selectively transmitted to the flap for moving the latter, and selectively not be transmitted to the flap so that the latter is held in position. It is thus not necessary to stop in a more or less abrupt way the movement of the actuating member once the flap is in the desired position. The latter can thus continue moving without this movement having any effect on the position of the flap.

Said complementary surfaces are for example substantially circular arcs of the same radius.

The guide path may be formed by a blind groove provided in the interface piece.

The groove may extend wholly or partly along a rectilinear axis intersecting the axis of rotation of the flap. Therefore, control of the flap can be simplified since the movement of the interface part thus corresponds exactly to the movement of the flap.

The complementary surface of a surface of the actuating member may be formed in the interface part by two portions of the periphery of the interface part, each of these two portions of the periphery being arranged on one side of the groove. The distance between each of said portions of the periphery and the groove may increase gradually as movement takes place into the groove towards the blind end.

Each of said portions of the periphery may be a circular arc of substantially the same radius.

Alternatively, the complementary surface of a surface of the actuating member may be formed in the interface part by at least a portion of the periphery of the interface part.

The actuating member may comprise a mobile part in rotation, a holding part of the interface part, and a guiding part of the interface part, said holding part and said guiding part being integral with the mobile part in rotation.

The axis of rotation of the mobile part can be parallel to that of the flap.

The guiding part may lie in the groove when the flap is in an intermediate position in which the first and the second ports are open.

The guiding part can exert a thrust on the interface part for moving the flap when said guiding part moves along the groove from the position corresponding to the intermediate position of the flap, as a result of rotation of the mobile part.

The holding part may include a recess providing a clearance to receive a portion of the interface part when the flap is in the intermediate position in which the first and second ports are open.

The complementary surface of a surface of the interface part can be formed in the actuating member by a portion of the outer periphery of the holding part.

In an exemplary embodiment of the invention, the rotating mobile part is a wheel, the holding part is a fraction of a coaxial wheel with the mobile part and having a smaller radius than that of the wheel forming the mobile part.

The wheel forming the mobile part is for example integrated in a gear coupled to the actuator.

According to this exemplary embodiment of the invention, the guiding part may be a lug or a pin attached to the wheel forming the mobile part, or even a ball bearing fitted on the pin.

The guiding part may be arranged angularly in the space freed by the recess in the holding piece.

According to this example, when the wheel forming the mobile part is moved in rotation by the actuator, a portion of its rotation is transmitted to the flap to move the latter when the guiding part, such as the pin or the lug, moves in the groove of the interface part, while another portion of the rotation of the wheel forming the mobile part is not transmitted to the flap which is then held in position when the guiding part is out of the groove, and when the complementary surfaces of the holding part and the interface room are cooperating.

The cooperation between said complementary surfaces can start as soon as the guiding part exits from the groove of the interface part.

In all the above, the device may or may not include one or more springs involved in maintaining the flap in position.

The invention also relates, according to another of its aspects, to an engine control valve having a switching device such as defined above.

The valve may include one input port and two output ports, the flap being pivotable to move from a blocking position of an output port to a blocking position of the other output port.

Alternatively, the valve may comprise two input ports and one output port, the flap being pivotable to move from a blocking position of an input port to a blocking position of the other input port.

The blocking of the path by the flap may be either full, and therefore be fully sealed, or partial by allowing a passage of residual fluid leakage, in particular gases.

The valve may, for example, be a valve used in an EGR loop.

A valve as described above has the advantage of implementing a switching device of the flap that is simple, especially because of the small number of parts involved, and therefore compact. Furthermore, it may offer the advantage of having an actuating member, such as a wheel forming a mobile part, which can continue moving after the flap has reached a blocking position, allowing said actuating member to fill an additional holding function during this additional displacement.

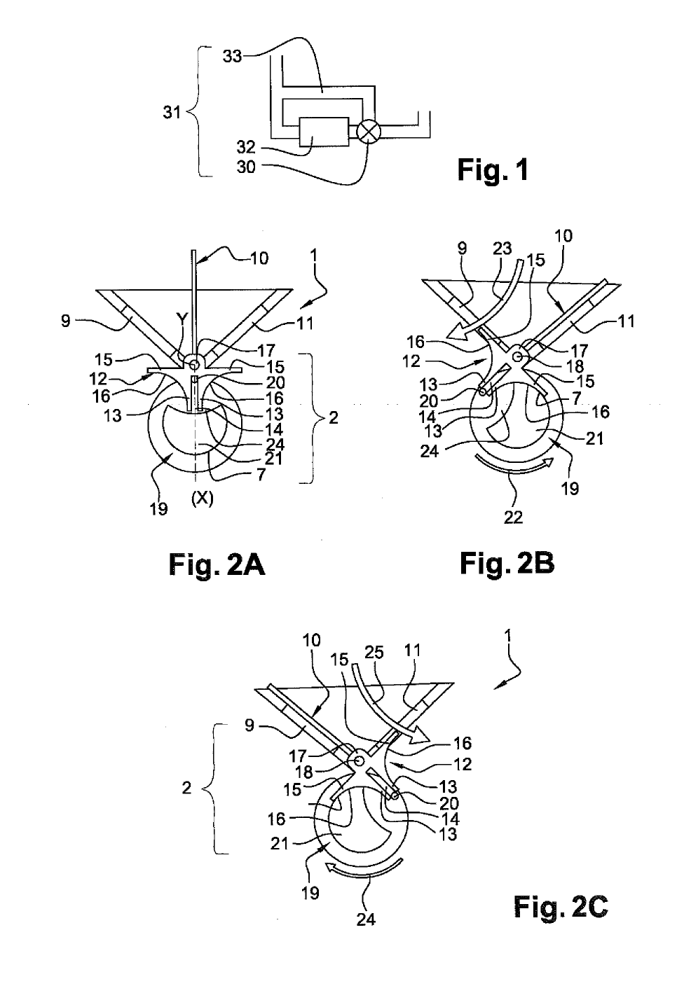

A detailed description of a non-limiting example of an embodiment of the invention, with reference to FIGS. 1 to 2C.

FIG. 1 is a schematic view of an engine control valve comprising a switching device according to the invention,

FIG. 2A is a schematic view of an actuating device for a valve according to the invention, the flap being in an intermediate opening position of the two ports,

FIG. 2B is a schematic view of the actuating device of FIG. 2A, the flap being in a blocking position of a port,

FIG. 2C is a schematic view of the actuating device of FIG. 2A, the flap being in a blocking position of the other port,

Referring to FIG. 1, a valve 30 shown therein is an engine control valve in which a switching device 1 according to the invention may be integrated.

The engine control valve 30 is, for example, an EGR valve placed in an EGR 31 loop of a thermal engine. The EGR loop 31 includes the valve 30, a cooler 32 of the EGR gases and a bypass channel 33 of said gases originating upstream of said cooler 32 and opening into the EGR loop 2 downstream of said cooler 32. The valve 30 includes a switching flap 10, plane and mobile in rotation between a first blocking position of the bypass channel 9 and a second blocking position of an access port 11 to the cooler 8.

Referring to FIGS. 2A to 2C, the flap 10 for closing the access port 9 to the bypass port 33, or the access port 11 to the cooler 32, is driven in rotation using a “Maltese cross” type mechanism whose principle is based on a discontinuous rotation of an object in a shape of a Maltese cross through a continuous rotation of a driving part interacting with said object. In the context of the invention, the object in the shape of a Maltese cross is an interface part 12 which was secured to the flap 10. This interface part 12 comprises two parallel arms 13 forming between them a groove 14 defining a guide path, as we shall see later, and two lateral protrusions 15, each of said protrusions 15 being placed on each side of the longitudinal axis of the groove 14.

The groove extends in this example along a straight longitudinal axis X.

An arm 13 and a protrusion 15 on the same side relative to the longitudinal axis of the groove 14 are connected to each other by an arcuate surface. The interface part 12 has a base 17 aligned with the longitudinal axis of the groove 14, the axis connecting the two protrusions 15 separating said base 17 and two arms 13. In this manner, each arm 13 has an end implanted in the base 17, and another end that is free. The flap 10 has an axis of rotation Y, allowing it to move between the two blocking positions of the two ports 9, 11, the interface part 12 being rigidly fixed to one end of the flap 10 through said base 17. Specifically, the interface part 12 is attached to the flap 10 so that the base 17 of the interface part 12 is crossed by the rotation axis Y of the flap 10. Thus, the rotation of the interface part 10 simultaneously drives the rotation of the flap 10 about its axis of rotation Y with the same angle.

In addition to the interface part 12, the switching device 1 comprises an actuating member 2 of the flap 10. The actuating member 2 comprises a part 19 movable in rotation, here a wheel 19, which can be driven by an actuator (not shown). The actuating member 2 further comprises a guiding part 20, here a lug attached to the wheel 19. The lug 20 is, for example, cylindrical and square and placed in the periphery and emerges in a perpendicular direction from the plane of the wheel 19.

The actuating member 2 further comprises a holding part 21, which is here a fraction of another wheel coaxial with the wheel 19, and integral with it. This other wheel 21 is arranged in the central area of the wheel 19. The other wheel 21 emerges in a perpendicular direction from the plane of the wheel 19, and thus creates an extra thickness. The cross section of the other wheel 21, which is perpendicular to its axis of rotation, presents a circular periphery 7 on more than half of its circumference, as well as a recess 24 delimited by a curved section connecting the partial circular periphery for closing said section.

Referring to FIG. 2A, when the flap 10 is in an intermediate opening position of both the bypass channel 33 and the access port 11 to the cooler 32, the lug 20 of the wheel 19 is positioned in the groove 14 near its bottom, the two arms 13 of the interface part 12 occupying the recess left vacant by the other wheel 21 and their free end leveling off the curved section of said other wheel 21.

Referring to FIG. 2B, when the wheel 19 is rotated by the actuator in the direction indicated by the arrow 22 located under said wheel 19, the lug 20 is guided in the groove 14, which causes the rotation of the interface part 12 and thus the flap 10 integral therewith, by exerting a thrust on one of the two arms 13 bordering said groove 14. The flap 10 eventually reaches a blocking position of the access port 11 to the cooler 32, allowing gases to enter into the bypass channel 9, as shown by the upper arrow 23 in the figure. Once the flap 10 has reached this blocking position, the wheel 19 continues to rotate so that a surface 16 in a circular arc of the interface part 12 bears against the other wheel 21, and more specifically against a complementary surface 7 thereof formed by a portion of the outer periphery of this other wheel 21. This portion of the other wheel 21 thus forms an abutment 7 contributing to hold the flap 10 in a blocking position of the access port 11 to the cooler 32 by bearing against said surface 16 in a circular arc of the interface part 12. The time from which the flap 10 is in a blocking position of the access port 11 to the cooler 32, corresponds to the exit time of the lug 20 from the groove 14.

Referring to FIG. 2C, the actuator can be activated to cause the rotation of the wheel 19 in the opposite direction, as indicated by the arrow 24 located under the wheel 19, so as to bring the flap 10 in a blocking position of the bypass channel 33 so that the gases flow through the access port 11 to the cooler 32, as shown by the upper arrow 25 in the figure. The flap 10 then passes again through the intermediate position of FIG. 2A to open momentarily and simultaneously the bypass channel 33 and the access port 11 to the cooler 32, before continuing its rotation to close the bypass channel 33.

1. A fluid switching device for a valve having at least three ports, the device comprising:
a flap pivotable between a first blocking position of a first port and a second blocking position of a second port;
an actuating member of the flap capable of moving the flap from one to the other of the blocking positions; and
an interface part capable of interacting with the actuating member, the device being configured so that this interaction selectively moves the flap by the actuating member and selectively holds the flap in position,
wherein the actuating member moving the flap via a guide path provided in the interface part.

2. The device according to claim 1, wherein the flap and the interface part are separate parts rigidly coupled together.

3. The device according to claim 1, wherein the actuating member and the interface part comprise complementary surfaces so that contact between these complementary surfaces holds the interface part in position upon movement of the actuating member.

4. The device according to claim 3, wherein said mating surfaces are circular arcs of substantially the same radius.

5. The device according to claim 3, wherein the guide path is formed by a blind groove provided in the interface part.

6. The device according to claim 5, wherein the groove extends along a rectilinear axis intersecting an axis of rotation of the flap.

7. The device according to claim 5, wherein the complementary surface of a surface of the actuating member is defined in the interface part by two portions of the periphery of the interface part, each of the two portions being arranged on one side of the groove.

8. The device according to claim 5, wherein the actuating member comprises a part mobile in rotation, a part for maintaining the interface part and a part for guiding the interface part, said holding part and said guiding part being integral with the part mobile in rotation.

9. The device according to claim 8, wherein the guiding part rests in the groove when the flap is in an intermediate position in which the first and the second ports are open.

10. The device according to claim 9, wherein the guiding part exerts a thrust on the interface part for moving the flap when said guiding part moves along the groove from the position corresponding to the intermediate position of the flap, due to a rotation of the mobile part.

11. The device according to claim 8, wherein the holding part comprises a recess providing clearance for receiving a portion of the interface part when the flap is in the intermediate position wherein the first and the second ports are open.

12. The device according to claim 5, wherein the complementary surface of a surface of the interface part is defined in the actuating member by a portion of the outer periphery of the holding part.

13. An engine control valve, comprising a switching device according to claim 1.

14. The engine control valve according to claim 13, further comprising one input port and two output ports, the flap being pivotable to move from a blocking position of one output port to a blocking position of the other output port.

15. The engine control valve according to claim 13, further comprising two input ports and one output port, the flap being pivotable to move from a blocking position of one input port to a blocking position of the other input port.
